(19) United States
(12) Patent Application Publication
(10) Pub. No.: US 2009/0327081 A1
(43) Pub. Date: Dec. 31, 2009

(54) System to Correlate Online Advertisement

(76) Inventors: Charles Wang, Union City, CA (US); Jessi Dong, Saratoga, CA (US); Sam P. Hamilton, Los Altos, CA (US); Michael Helman, Oakland, CA (US); Chris Kalaboulds, Los Gatos, CA (US); Jianbin Wei, Menlo Park, CA (US)

Correspondence Address: STATTLER - SUH PC, 60 SOUTH MARKET STREET, SUITE 480, SAN JOSE, CA, 95113, US

(21) Appl. No.: 12/163,114

(22) Filed: Jun. 27, 2008

(51) Int. Cl. G06Q 30/00

(52) U.S. Cl. 705/14.66

(57) ABSTRACT

This patent discloses a method to display an online advertisement to a user. The online advertisement may include an object ad profile, at least one user ad profile, and a users personal profile. The method may determine whether to display the online advertisement to the user by comparing at least one of (i) a personal profile of the user and an ad profile of the user to at least one of (ii) the object ad profile, the at least one user ad profile, and the users personal profile.

### BACKGROUND

1. Field

The information disclosed in this patent relates to displaying an Internet advertisement as a function of user behavior.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

Many websites host advertisements of others as a way to generate revenue. Advertisers may pay these websites per banner impression (CPM), pay per click (PPC), pay per action accomplished, or under some other agreed upon billable event. A goal of online advertising is to improve sales for the advertisers and increase the billable events for the host website. What is needed is a system to address these and other issues.

### SUMMARY

This patent discloses a method to display an online advertisement to a user. The online advertisement may include an object ad profile, at least one user ad profile, and a users personal profile. The method may determine whether to display the online advertisement to the user by comparing at least one of (i) a personal profile of the user and an ad profile of the user to at least one of (ii) the object ad profile, the at least one user ad profile, and the users personal profile.

### BRIEF DESCRIPTION OF THE FIGURES

FIG. 1 is a block diagram illustrating a system 100.

FIG. 2 is drawing of an object 200.

FIG. 3 is a data flow diagram illustrating a method 300 to display online advertisement 102 to user 10.

FIG. 4 illustrates a network environment 400 for operation of the platform 100.

### DETAILED DESCRIPTION

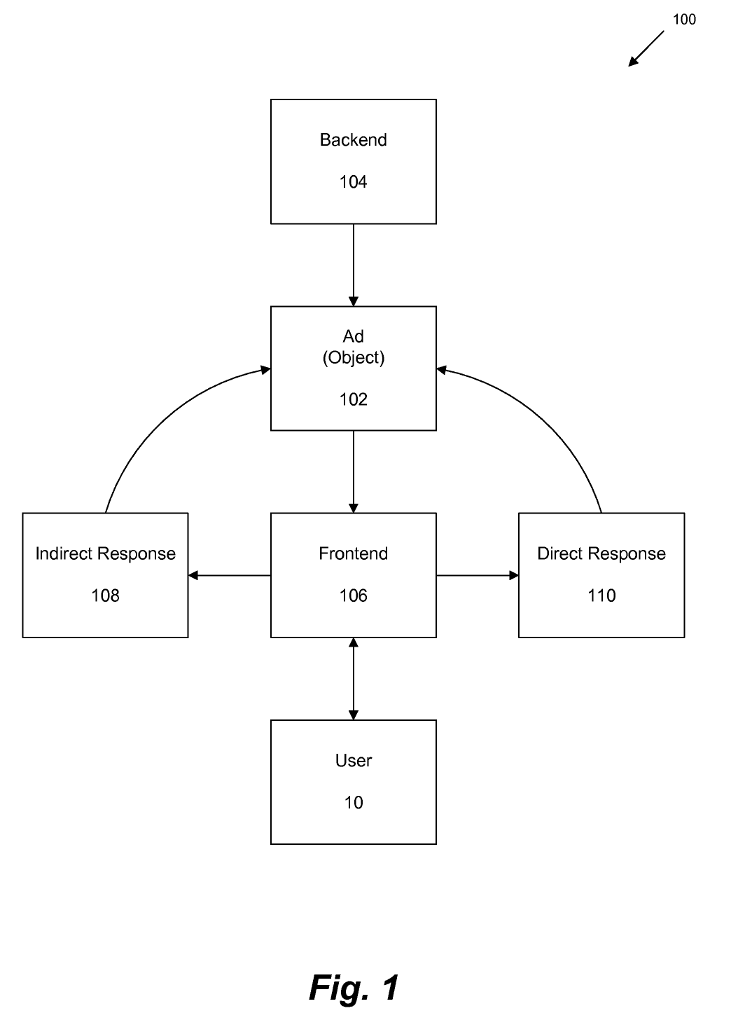

FIG. 1 is a block diagram illustrating a system 100. System 100 may be a group of independent but interrelated elements that may determine whether to display one advertisement 102 to one user 10. The decision to display advertisement 102 to the individual behind user 10 is important because each display—each advertising impression made on a computer screen—may mean that an advertiser has purchased that advertising impression. On the Internet, advertising impressions reach into the millions rather quickly and each of those millions of advertising impressions may represent millions of purchases by the advertiser. By reducing the number of advertising impressions to those more likely to result in a prospective customer 10 taking the advertiser's intended action, system 100 may improve the return over investment for the advertiser and the web browsing experience of user 10.

System 100 may make the decision to display advertisement 102 to user 10 based on correlations between advertisement 102 and user 10. Those correlations need not be content base, but may be based on behaviors of user 10. System 100 may determine correlations between advertisement 102 and user 10 by predicting whether user 10 has a makeup similar to other users who responded to advertisement 102. Here, system 100 may seek to match online advertisement 102 to those users 10 who may have some sort of interest in or related to advertisement 102.

Prior user click-through suggestions, opinions, and movement behaviors may be set out as metadata in advertisement 102. System 100 may draw correlations between prior user click-through suggestions, opinions, and movement behaviors set to a present user personal and advertising profile. On determining that a present user 10 may be a match for advertisement 102, system 100 may display advertisement 102 to user 10. Thus, system 100 may improve engagement with and performance of a particular advertisement 102.

In addition to advertisement 102, system 100 may include a backend 104 and a front end 106. Advertisement 102 may receive initial input from backend 104 and convey itself to user 10 at front end 106. User 10 may indirectly or directly respond to advertisement 102 and feedback may be send to advertisement 102 through an indirect response 108 and a direct response 110.

Advertisement 102 may be an announcement called to the attention of the public 10. For example, advertisement 102 may include an announcement to make something known, especially to persuade people 10 to buy whatever is advertised. Advertisement 102 may be a communication to inform potential customers 10 about products and services, about how to obtain them, and use them. Advertisement 102 may be an online advertisement when displayed on an Internet webpage. As display advertising-content appearing on a webpage, advertisement 102 may be in a form such as a banner, a half banner, a streaming banner, a button, an interactive button ad, a clickable ad, mail, raw text, a rectangle, and a skyscraper and may range in size from 25×25 to 728×210, for example. Advertisement 102 may be in any other possible sizes or ad forms.

Backend 104 may include those responsible for the creation and management of advertisement 102. For example, an advertiser or ad agency may create advertisement 102 and may pay a host website to display and maintain advertisement 102. The advertiser, ad agency, and host website may be part of backend 104. Marketers, developers, the press, publishers, and small businesses may be part of backend 104 as well.

Front end 106 may include user 10 and other individuals to whom advertisement 102 may be displayed. User 10 may provide indirect response 108 about advertisement 102 such as through a feedback system. Additionally, user 10 may provide direct responses 110 about advertisement 102 such as through clicking on advertisement 102, performing a mouseover advertisement 102, or not reacting to advertisement 102.

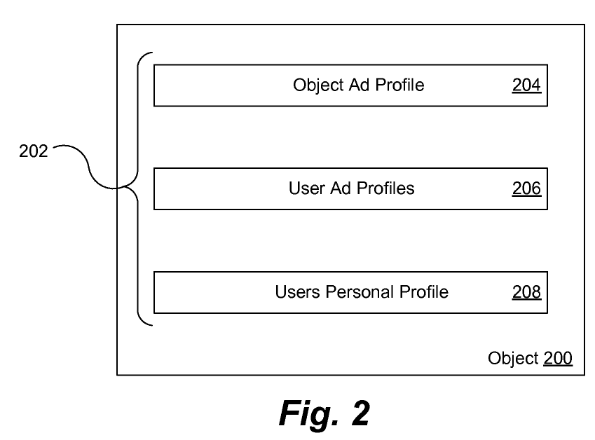

FIG. 2 is drawing of an object 200. Object 200 may be advertisement 102 configured to be an image displayed on an Internet website. Object 200 may include display advertising content. Additionally, object 200 may be referred to as an ad object, an advertisement object, an online advertisement, an online advertisement object, and an HTML creative.

The Internet is a vast computer network linking smaller computer networks worldwide and allowing interaction into this network through websites. Image displayed on a webpage of a website, including object 200, may be composed of computer source code presented in a markup language such as Hypertext Markup Language and a scripting language such as JavaScript. Some of the source code may be dedicated to those items visually displayed online and other parts of the source code may be dedicated to data that may profile object 200.

Object 200 may include a dataset 202. Dataset 202 may be a collection of data presented in tabular form that may profile object 200. Each column may represent a particular variable and each row may correspond to a given member of the data set in question. Dataset 202 may include an object ad profile 204, user ad profiles 206, and a users personal profile 208 as a personal profile of one or more users.

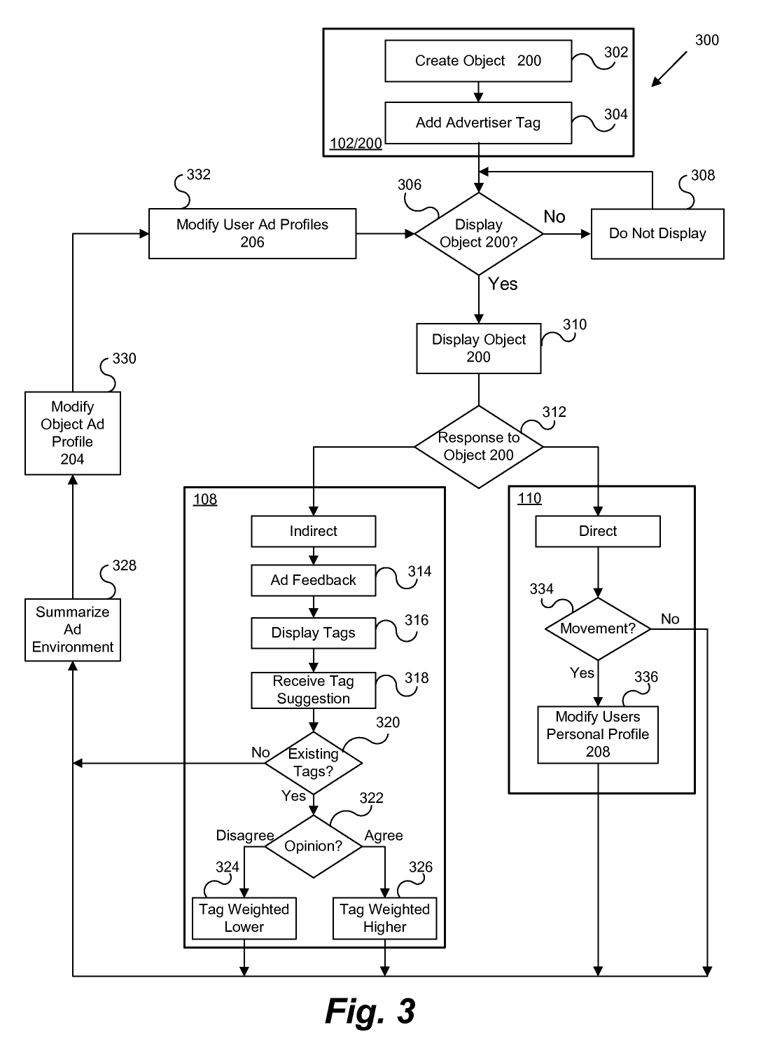

Much like user 10 may have a detailed personals listing in order to find a mate through an online dating service, object ad profile 204 may include a detailed personals style profile. Object ad profile 204 may include placement and accounting data such as position of the advertisement on a webpage, interactive (rich) media/standard media, the name of the advertiser, the marketing campaign start/end, impression goal, the advertising budget, and how advertisement revenue is generated, such as cost per click (CPC) or cost per mille (CPM). To better match user 10 to object 200 (advertisement 102), object ad profile 204 may include additional information, such as suggestion, opinion, and movement behavior of each user 10 to which advertisement 102 may be displayed. As described in more detail in connection with FIG. 3, this information may be modified and added to each time object 200 is displayed to a user 10.

User ad profiles 206 may be an advertisement profile of each user 10 to whom object 200 was displayed. User ad profiles 206 may keep track of those kinds of advertising features each user 10 may be more likely to respond. User ad profiles 206 additionally may include data about the time of day, colors, shopping items, webpage content, time by rate, and time by purchase as they relate to advertisement 102.

Users personal profile 208 may be a compilation of user personal profile data received from accessible personal profiles of each user 10 that may click through advertisement 102. As an example, users personal profile 208 may keep track of the number of women who click through advertisement 102. In addition to gender, users personal profile 208 may keep track of average ages, zip codes, email address, occupation, income level, industry, ethnographic information, purchase history, and personal interests of users 10 that may click through advertisement 102. Each of these may be analyzed to produce users personal profile 208 as a compiled personal profile of all users 10 that clicked through advertisement 102.

FIG. 3 is a data flow diagram illustrating a method 300 to display online advertisement 102 to user 10. Method 300 may be implemented in a computer readable medium having a set of instructions. When executed by a computer, the set of instructions may cause the computer to display online advertisement 102 to user 10 according to method 300.

At step 302, object 200 may be created. Creating object 200 may include providing a distinct border to identify where the webpage ends and the advertisement begins. Within the distinct border may be text, standard graphics or rich animation graphics that does not exceed a predetermined amount of run time such as fifteen seconds, the identity of the advertising message sponsor, branding, linking Uniform Resource Locator (URL)s, and other items.

At step 304, object 200 may receive an advertiser tag as part of object ad profile 204. Here, the creator of advertisement object 200 may provide an initial data set for dataset 202. The data set may include data for object ad profile 204, such as a desired advertisement spot for advertisement 200 on a webpage, the name of the advertiser, the marketing campaign start/end date, an impression goal, the advertising budget, and whether the marketing campaign is to be CPC or CPM based. There may be overlap between that which may be displayed on a computer screen and data that may be part of object ad profile 204.

The advertiser tag may be used to specify page description, keywords, and any other metadata. For example, the advertiser tag may include the keywords “Ford Mustang GT convertible,” “red,” and “sports car” for an automobile advertisement. Since the tag is from the advertiser, the tag may receive significant weight as being representative of the advertisement. Each of the keywords may have weight that may vary overtime.

At step 306, method 300 may determine whether to display object 200/advertisement 102 to user 10. If method 300 determines not to display object 200/advertisement 102 to user 10, method 300 may proceed to step 308 where object 200 is not displayed to user 10. From step 308, method 300 may return to step 306. If method 300 determines to display object 200/advertisement 102 to user 10, method 300 may proceed to step 310.

The decision to display object 200 to user 10 may be important. Many advertising contracts may be based on page impression—the loading of a single page with object 200. Whether cost per impression or cost per 1,000 impressions (Cost per Mille, CPM), the advertising billable events quickly may add up. By making intelligent decisions on whether to display object 200 to a user 10, method 300 may reduce the number of advertising impressions to those more likely to result in a prospective customer taking the marketer's intended action (known as a marketing conversion). With the number of advertising impressions reduced, the CPM may go down while the rate of marketing conversions may increase. In other words, an advertiser's return over investment may be higher since the advertiser receive more engaged users for ever impression the advertiser purchases. User 10 may benefit by seeing advertisements that may be more relevant to needs and desires of that particular user 10.

The decision to display object 200 to user 10 may be a function of a match between (i) a personal profile of user 10 and an ad profile of user 10 (e.g., the user ad profile 206 specific to this user 10) and (ii) object ad profile 204, user ad profiles 206 of other users 10, and users personal profile 208. Table 1 below set out an A column and a B column:

TABLE 1

| | | B. Other |
|---|---|---|
| | A. This user 10 | contributors to object 200 |
| Correla- | 1. Personal profile of user 10 | 1. Object ad profile 204 |
| tion | 2. Ad profile of user 10 (206) | 2. User ad profiles 206 |
| | | 3. Users personal profile 208 |

In general, data from column A may be compared to data from column B to determine. Method 300 then may determine whether there is a correlation between data that may characterize user 10 and data that may characterize object 200. Data that may characterize user 10 may include a personal profile of user 10 and an ad profile of user 1O. As discussed above in connection with FIG. 2, data that may characterize object 200 may include object ad profile 204, user ad profiles 206, and users personal profile 208.

Determining whether there is a correlation between user 10 and object 200 data characterization may be achieved through a variety of techniques, such as association rule learning, collaborative filtering, principle of maximum entropy, and gradient descent. In data mining and treatment learning, association rule learners may be utilized to discover elements that co-occur frequently within a data set. Collaborative filtering includes filtering for information or patterns using techniques involving collaboration among multiple agents, viewpoints, and data sources. Principle of maximum entropy includes analyzing available qualitative information to determine a unique epistemic probability distribution, where a least biased distribution that encodes certain given information may be that which may maximize the information entropy. In gradient descent, steps proportional to the negative of the gradient (or the approximate gradient) of the function at the current point may be taken to find a local minimum of a function.

Data for user ad profiles 206 and users personal profile 208 may be retrieved from those users 10 for which object 200 may be displayed. For the very first display of object 200, user ad profiles 206 and users personal profile 208 may be empty of data and the display decision at step 306 may be based on information provide by backend 104 to object ad profile 204. As method 300 continues, an iterative process of method 300 may modify and/or add to object ad profile 204, user ad profiles 206, and users personal profile 208 to improve an effectiveness of an advertisement 102 at being displayed to a target user 10.

In addition to displaying object 200 to user 10, system 100 additionally may suggest to user 10 to visit other property of the host website. For example, if user 10 is using Yahoo! Answers and clicks on an auto advertisement and the match between user 10 and object 200 reveals an interest of user 10 in autos, system 100 may suggest to user 10 that they may want to visit Yahoo! Autos as well. Other property that may be suggested may include, but not be limited to, classifieds, Ebay, Fifa, finance, Flickr, games, groups, health, Hotjobs, Knowledge Search, Launch.com, mail, mobile, movies, music, news, pager, personals, photos, real estate, shopping, sports, travel, and TV. Machine learning techniques to leverage existing data to extract interesting information may be utilized to implement this property-to-property correlation. In one example, the machine learning techniques may include neural networks to infer properties.

In addition to displaying object 200 to user 10, system 100 additionally may utilize the determination at step 306 to re-flavor of redesign a site around the kinds of ads on which user 10 may be clicking. For example, if user 10 tends to click on any auto ads, the flavor of the webpages presented to user 10 over time may become more auto related with auto imagery appearing in a subtle way as user 10 continues to use the site and click on ads.

At step 310, method 300 may display object 200 to user 10. In alternate example, other useful content first may be displayed on the advertisement spot. In this example, object 200 may include code that may display other useful content on the advertisement spot instead of requesting that advertisement 200 be displayed on the advertisement spot. The useful content may include an excerpt of an informative relevant article that may lead user 10 to advertisement 200. In this example, advertisement 200 may be configured as a more powerful landing page having a more powerful message. The more powerful message may include a mix of an advertisement or content. This technique may combat banner blindness where visitors on a website ignore an area of a webpage merely because it contains an advertisement. Both the display of the other useful content and any subsequent display of advertisement 200 may be included in step 310 as part of displaying object 200 to user 10.

At step 312, method 300 may determine whether object 200 has been indirectly or directly been responded to by user 10. An indirect response may include selecting an ad feedback link to bring up a survey and a direct response may include engaging object 200 or not engaging object 200. If method 300 determines that object 200 has been directly been responded to by user 10, method 300 may proceed to step 334. If method 300 determines that object 200 has been indirectly been responded to by user 10, method 300 may proceed to step 314.

At step 314, method 300 may have received an ad feedback selected message. In an example, an ad feedback link may appear below object 200. The ad feedback link may be a compact string of characters that lead to a survey via the website. Selecting the ad feedback link may give viewers of object 200 ability to rate, tag, and vote regarding object 200. The ad feedback may include additional features such as an ad toolbar and referral option that may treat object 200 like any other piece of content to be affected by user content. These features may allow a richer response to object 200 beyond a survey response. In a further example, method 300 may receive notification at step 314 that user 10 referred object 200 to one or more friends as an indirect response to object 200.

At step 316, any tags for object 200 may be shown to user 10 through a popup survey window, for example. Tags may be ad profile tags and suggested tags. Ad profile tags may be maintained within object ad profile 204. Suggested tags may be maintained in user ad profiles 206.

Ad profile tags may be those tags that have met a first predetermined acceptance threshold. For example, any tags provided at step 304 may meet the predetermined acceptance threshold. Suggested tags may be those tags that have met a second predetermined acceptance threshold. The second predetermined acceptance may be lower than the first predetermined acceptance threshold. Suggested tags may be those tags from previous users 10 that have receive a high enough weight to exceed the second predetermined acceptance. In addition, suggested tags may be machine-generated tags based on those tags that other users may have previously entered.

At step 318, system 100 may receive a tag suggestion from user 10. At step 320, method 300 may determine whether any tags were shown to user 10 at step 316. If no tags where shown at step 316, method 300 may proceed to step 328. If tags where shown at step 316, method 300 may proceed to step 322.

At step 322, method 300 may determine whether user 10 disagrees or agrees with the tag. If method 300 determines that user 10 disagrees with the tag, then that tag may be weighted lower at step 324. If the tag weight is below or falls below the first predetermined threshold, then that tag may be classified as a suggested tag and not be classified as an existing tag. If the tag weight is below or falls below the second predetermined threshold, then that tag may be removed from being classified as a suggested tag and no longer displayed to any user 10. From step 324, method 300 may proceed to step 328.

If method 300 determines that user 10 agrees with the tag, then that tag may be weighted higher at step 326. If the tag weight is above or rises above the second predetermined threshold, then that tag may be classified as a suggested tag to be displayed to a user 10. If the tag weight is above or rises above the first predetermined threshold, then that tag may be classified as an existing tag. Ad profile tags may contribute to the advertisement display decision at step 306. From step 326, method 300 may proceed to step 328.

At step 328, method 300 may summarize an environment in which object 200 was displayed. Part of that environment may include a URL of the webpage on which the ad was displayed at the time user 10 selected ad feedback at step 314 and the fact that user 10 selected ad feedback at step 314.

A user 10 may be interested in an advertisement for reasons other than content. For example, the location of the ad on the webpage may draw interest in a user 10 to respond to the ad or the fact the ad has flash animation and interactivity may draw interest in a user 10 to respond to the ad. In some instances, the mere fact that the advertisement is blue may be sufficient to draw interest in a user 10 to respond to the ad. Importantly, method 300 need not pre-categorize an ad to match certain users 10; rather method 300 may seek to find correlations between object 200 and users 10, whether those correlations may be based on content or some other reason. Summarizing an environment in which object 200 was displayed may aid in making such a determination.

From step 328, method 300 may proceed to step 330. At step 330, method 300 may modify object ad profile 204. Modifying object ad profile 204 may include adding the tag from step 318 to object ad profile 204 and adding/removing tags from object ad profile 204 based on their weight change after step 322. In addition, object ad profile 204 may be modified with aspects from the environment in which object 200 was displayed.

At step 332, method 300 may modify user ad profiles 206. Modifying user ad profiles 206 may include creating a new user ad profiles 206 for user 10 or changing an existing user ad profiles 206 for user 10. In one embodiment, system 100 may include a machine-learning model to determine for each user 10 what kind of features user 10 would be more likely to click. As noted above, user ad profiles 206 may keep track of those kinds of features each user may be more likely to click. User ad profiles 206 additionally may include data about the time of day, colors, shopping items, time by rate, and time by purchase as they relate to advertisement 102. Further, user ad profiles 206 may be modified with aspects from the environment in which object 200 was displayed. Importantly, each user ad profile 206 may travel with its associated user 10 to be added to each object 200 displayed to that user 10. Thus, the prior advertising experiences of each user may be brought into determining whether to display object 200 to one particular user 10 at step 306. From step 332, method 300 may return to step 306.

As noted above, method 300 may proceed to step 334 if method 300 determines at step 310 that object 200 has been directly been responded to by user 10. At step 334, method 300 may determine whether the engagement with object 200 was movement or no movement. Movement may include click through, mouseover, and other movement such as conversion. Point-and-click is an action of computer user 10 moving a cursor to a certain location on a screen (point) and then pressing a mouse button, usually the left one (click), or other pointing device. Mouseover may refer to a graphical user interface (GUI) event that may be raised when user 10 moves or “hovers” the cursor over a particular area of the GUI. Clicking may represent a high interest level and mouseover may represent a medium interest level. Conversion may represent a very high interest level. For example, if object 200 was constructed to accept a signup from user 10 for an emailing list and user 10 entered the signup date into object 200, the event may be considered a conversion demonstrating a very high level of interest in object 200. If method 300 determines that the engagement with object 200 was a lack of movement, then method 300 may proceed to step 328. If method 300 determines that the engagement with object 200 was movement, then method 300 may proceed to step 336.

In some cases, system 100 presently may not know much about user 10. However, if user 10 is logged in or has a cookie, a full set of demographic data may be available on user 10. If user 10 makes movement against object 200, then demographic information about user 10 may be added into users personal profile 208 at step 336. If object 200 appeals to women, based on the number of women that have made movement relative to object 200, then users personal profile 208 may contain sufficient data to make such a determination and object ad profile 204 may be modified to skew the display of object 200 at step 306 towards being displayed to women. From step 338, method 300 may proceed to step 328.

After summarizing the environment at step 328, method 300 may proceed to step 330 and step 332. At step 332, method 300 may modify user ad profiles 206 such as by looking at the conversion of clicking on object 200 to an actual sale such as may have occurred at step 334. Clicking, mouseover, or other movement data from step 334 such as the x-y coordinate of the click or mouseover pause on the advertisement may be added to user ad profiles 206.

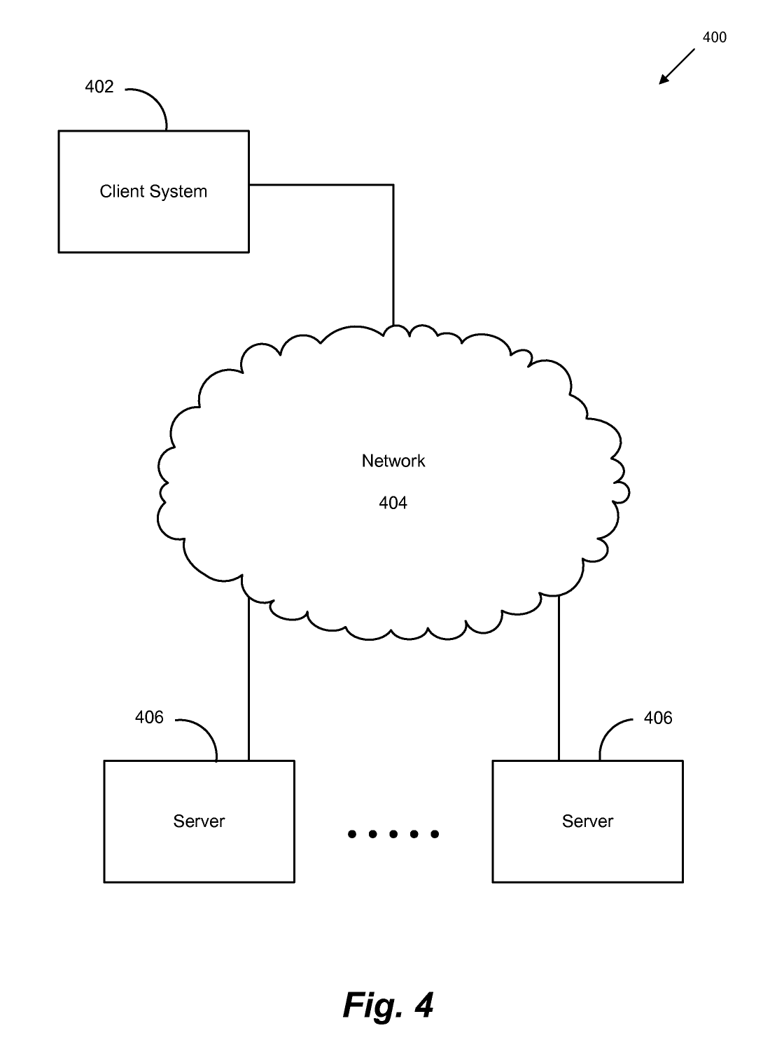

FIG. 4 illustrates a network environment 400 for operation of the platform 100. The network environment 400 may include a client system 402 coupled to a network 404 (such as the Internet, an intranet, an extranet, a virtual private network, a non-TCP/IP based network, any LAN or WAN, or the like) and server systems 4061 to 406N. A server system may include a single server computer or a number of server computers. Client system 402 may be configured to communicate with any of server systems 4061 to 406N, for example, to request and receive base content and additional content (e.g., in the form of photographs).

Client system 402 may include a desktop personal computer, workstation, laptop, PDA, cell phone, any wireless application protocol (WAP) enabled device, or any other device capable of communicating directly or indirectly to a network. Client system 402 typically may run a web-browsing program that may allow a user of client system 402 to request and receive content from server systems 4061 to 406N over network 404. Client system 402 may one or more user interface devices (such as a keyboard, a mouse, a roller ball, a touch screen, a pen or the like) to interact with a graphical user interface (GUI) of the web browser on a display (e.g., monitor screen, LCD display, etc.).

In some embodiments, client system 402 and/or system servers 4061 to 406N may be configured to perform the methods described herein. The methods of some embodiments may be implemented in software or hardware configured to optimize the selection of additional content to be displayed to a user.

An ad server may include a computer server, such as a web server, that may store advertisements used in online marketing and may deliver them to website visitors by placing the advertisements on web sites. In one example, client system 402 and/or system servers 4061 to 406N may include or be part of an ad server. In addition to updating the contents of the web server so that the website or webpage on which the ads are displayed may contain new advertisements, the ad server may perform various other tasks such as counting the number of impressions/clicks for an ad campaign and report generation. The ad server may be a local ad server run by a single publisher and serve ads to that publisher's domains or may be a third-party, remote ad server that serve ads across domains that may b e owned by multiple publishers.

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A method to display an online advertisement to a user, the method comprising:
presenting an online advertisement having an object ad profile, at least one user ad profile, and a users personal profile; and
determining whether to display the online advertisement to the user by comparing at least one of (i) a personal profile of the user and an ad profile of the user to at least one of (ii) the object ad profile, the at least one user ad profile, and the users personal profile.

2. The method of claim 1, where determining whether to display the online advertisement includes utilizing at least one of association rule learning, collaborative filtering, principle of maximum entropy, and gradient descent.

3. The method of claim 1, further comprising:
retrieving data from those users for which online advertisement is displayed, where the retrieved data includes at least one of a suggested tag, an opinion from the user about a tag, and user personal profile data.

4. The method of claim 3, where user personal profile data is retrieved only if the engagement of the user with the online advertisement is through movement of a mouse pointer.

5. The method of claim 3, further comprising:
modifying at least one of the ad profile of the user, the object ad profile, the at least one user ad profile, and the users personal profile with the retrieved data.

6. The method of claim 5, where modifying includes at least one of adding the suggested tag to the user ad profile, adding the user personal profile data to the users personal profile of the online advertisement, and adding the opinion from the user about a tag to at least one of the user ad profile and the object ad profile.

7. The method of claim 3, where the opinion from the user about a tag is added to the object ad profile if the tag is an ad profile tag.

8. The method of claim 1, further comprising:
determining whether the online advertisement is one of indirectly and directly responded to by the user.

9. The method of claim 8, further comprising:
displaying tags of the online advertisement to the user if the online advertisement is indirectly responded to by the user.

10. The method of claim 9, further comprising:
determining whether the user one of agrees and disagrees with each displayed tag.

11. The method of claim 1, after determining to not display the online advertisement to the user, the method further comprising:
refraining from displaying the online advertisement to the user; and
returning to determining whether to display the online advertisement to the user.

12. A computer readable medium comprising a set of instructions which, when executed by a computer, cause the computer to display an online advertisement to a user, the instructions for:
presenting an online advertisement having an object ad profile, at least one user ad profile, and a users personal profile; and
determining whether to display the online advertisement to the user by comparing at least one of (i) a personal profile of the user and an ad profile of the user to at least one of (ii) the object ad profile, the at least one user ad profile, and the users personal profile.

13. The computer readable medium of claim 12, further comprising:
retrieving data from those users for which online advertisement is displayed, where the retrieved data includes at least one of a suggested tag, an opinion from the user about a tag, and user personal profile data.

14. The computer readable medium of claim 12, where user personal profile data is retrieved only if the engagement of the user with the online advertisement is through movement of a mouse pointer.

15. The computer readable medium of claim 12, further comprising:
modifying at least one of the ad profile of the user, the object ad profile, the at least one user ad profile, and the users personal profile with the retrieved data, where modifying includes at least one of adding the suggested tag to the user ad profile, adding the user personal profile data to the users personal profile of the online advertisement, and adding the opinion from the user about a tag to at least one of the user ad profile and the object ad profile.

16. The computer readable medium of claim 12, further comprising:
determining whether the online advertisement is one of indirectly and directly responded to by the user; and
displaying tags of the online advertisement to the user if the online advertisement is indirectly responded to by the user.

17. The computer readable medium of claim 12, after determining to not display the online advertisement to the user, the method further comprising:
refraining from displaying the online advertisement to the user; and
returning to determining whether to display the online advertisement to the user.

18. An ad server, comprising:
an online advertisement configured to be displayed to a user, the online advertisement having an object ad profile, at least one user ad profile, and a users personal profile.

19. The ad server of claim 18, where the at least one user ad profile includes a suggested tag from the user.

20. The ad server of claim 18, where the at least one user ad profile includes an opinion from the user about a tag.

21. The ad server of claim 20, where the object ad profile includes the opinion from the user about the tag.

22. The ad server of claim 18, where the users personal profile includes the user personal profile data of at least two users.
